(19) United States
(12) Patent Application Publication
(10) Pub. No.: US 2002/0162638 A1
(43) Pub. Date: Nov. 7, 2002

(54) Procedure for loading fibers

(76) Inventor: Klaus Doelle, Menusha, WI (US)

Correspondence Address: Todd T. Taylor, TAYLOR & AUST, P.C., 142 S. Main St., P.O. Box 560, Avilla, IN, 46710, US

(21) Appl. No.: 10/128,189

(22) Filed: Apr. 23, 2002

(30) Foreign Application Priority Data
Apr. 27, 2001 (DE) DE 10120637.2

(51) Int. Cl. D21H 17/00; D21F 11/00; D21H 17/63; C01B 31/20

(52) U.S. Cl. 162/158; 162/181.1; 162/181.2; 162/183; 423/437.1

(57) ABSTRACT

In a procedure for loading fibers contained in a pulp suspension with an additive by means of a chemical precipitation reaction, which is initiated through adding carbon dioxide, the carbon dioxide is produced with a degree of purity of ≦99%, preferably of ≦85%, and this carbon dioxide is then added to the pulp suspension.

### BACKGROUND OF THE INVENTION

1. Field of the Invention.

The present invention relates to the manufacture of paper and board, and more particularly to a procedure for loading fibers contained in a pulp suspension with an additive by way of a chemical precipitation reaction, which is initiated through adding carbon dioxide.

2. Description of the Related Art.

In the fiber preparation phase, prior to the paper machine phase, the fiber pulp used to manufacture paper and board is prepared in a manner, which allows the desired paper properties (e.g., mechanical properties, optical properties, etc.) to be achieved. This process may involve the addition of additives (e.g., fillers) to the fibers.

The process of loading fibers with an additive (e.g., a filler) may, for example, be effected through a chemical precipitation reaction, in particular through the use of a so-called “Fiber Loading™ Process”, as described in U.S. Pat. No. 5,223,090, among other documents. In this type of “Fiber Loading™ Process”, at least one additive, in particular a filler, is deposited on the wetted fiber surfaces in the fibrous material. This process may involve loading the fibers with calcium carbonate, for example. To achieve this, calcium oxide and/or calcium hydroxide are added to the fibrous material in its wet, disintegrated state in such a way that at least a portion of this calcium oxide/hydroxide becomes associated with the water contained in the fibrous material. The fibrous material processed in this way is then charged with carbon dioxide. In the procedure known from U.S. Pat. No. 5,223,090, the “Fiber Loading™ Process” can be performed in a refiner.

When the medium containing calcium oxide and/or calcium hydroxide is added to the pulp suspension, a chemical reaction of an exothermic nature is initiated. The calcium hydroxide added to the suspension is preferably in a liquid form (milk of lime). This implies that the water, which may possibly be deposited in or attached to the fibers in the pulp suspension, is not necessarily required at the start and during the course of the chemical reaction.

To date, the carbon dioxide for the type of fiber loading process described above has generally been produced with a degree of purity exceeding 99.8%. Producing carbon dioxide with this degree of purity is relatively costly and laborious. This represents a disadvantage in terms of the economic viability of the fiber loading process as a whole. What is needed in the art is a procedure for loading fibers with an additive using less pure carbon dioxide.

### SUMMARY OF THE INVENTION

The present invention provides an improved procedure for loading fibers with an additive using less pure carbon dioxide. An advantage of the present invention is enabling the overall procedure to be performed in a correspondingly simpler and more economical manner.

This goal is accomplished, according to one embodiment of the present invention, by a procedure for loading fibers contained in a pulp suspension with an additive, effected by way of a chemical precipitation reaction which is initiated through adding carbon dioxide, whereby the carbon dioxide is produced with a degree of purity of ≦99%, preferably of ≦85%, before being added to the pulp suspension.

It has become clear that this lower degree of purity according to the present invention, which is substantially lower than in previously known procedures, is however, perfectly sufficient for the fiber loading process currently under discussion. The procedure according to the present invention is thus particularly advantageous, since it enables significant reductions to be made in the energy required to obtain the carbon dioxide, and it allows radical simplification in both the facility used to produce the carbon dioxide, as well as the manufacturing process. As a result, the fiber loading process as a whole is made simpler and more economical.

The carbon dioxide is preferably generated from the waste gas of a fuel, or through lime burning or a similar process.

According to a preferred embodiment of the procedure according to the present invention, the carbon dioxide is produced from the waste gas of a power station, a combustion engine, a boiler and/or similar, and/or from the waste gas taken from direct firing of any desired fossil fuel.

The waste gas produced in the combustion process is advantageously submitted to a washing process, in particular to wash out major and solid contaminants from the waste gas. At least one wet tower scrubber may be employed for this washing process.

It is also advantageous for the gas to be absorbed in an absorber liquid, preferably subsequent to the washing process. The absorber liquid can contain highly effective monoethanolamine (MEA) and/or a soda ash and/or copper carbonate and water mixture.

Subsequently, the absorbed carbon dioxide can be precipitated, whereby it is preferably also cooled. By preference, at least one part of the process steps described above is performed in a counter-current direction.

In certain cases, it may be advantageous for the gas to be compressed, and preferably cooled, for purposes of liquefaction, and for the liquid carbon dioxide to subsequently be stored in a pressurized tank, and thus made available for the fiber loading process. For the fiber loading process, this carbon dioxide, which has been stored in liquid form, may then be heated to a temperature in the region of between approximately 10° C. and approximately 90° C., in order to achieve the chemical structure required in the specific case. Subsequent to this, the carbon dioxide in a gaseous state can be fed into the fiber loading process.

However, it is also possible to introduce the carbon dioxide in its gaseous state directly into the fiber loading process, preferably after washing/precipitation. Heating or cooling may still be employed in this process to bring the carbon dioxide to the desired temperature before it is introduced into the fiber loading process.

Particularly in cases where the carbon dioxide is fed directly into the fiber loading process, the processes of compression and cooling may be omitted, at least in part, since all that is required is to heat or cool the CO₂ gas to its final desired temperature, and compress it to the desired pressure.

In the present application of carbon dioxide for a fiber loading process, neither purification (i.e. odor neutralization) nor ultra purification is required.

In the course of loading the fibers (e.g., with a filler), calcium carbonate (CaCO₃) may be deposited onto the wetted fiber surfaces, by adding calcium oxide (CaO) and/or calcium hydroxide (Ca(OH)₂) to the wet fibrous material, whereby at least a portion of this calcium oxide/hydroxide becomes associated with the water contained in the fiber pulp. The fibrous material processed in this way can then be charged with carbon dioxide (CO₂), which has been produced in the aforementioned manner.

The term “wetted fiber surfaces” includes all wetted surfaces of the individual fibers. In particular, this includes situations where the fibers are loaded with calcium carbonate (or any other precipitant), both on their external surfaces and on their internal surfaces (lumen).

Accordingly, the fibers can be loaded with the filler calcium carbonate, for example, whereby deposition on the wetted fiber surfaces is effected through a so-called “Fiber Loading™ Process”, as this process is described in U.S. Pat. No. 5,223,090. In this “Fiber Loading™ Process”, the carbon dioxide reacts with the calcium hydroxide to form water and calcium carbonate.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a flow diagram of an example embodiment of the procedure according to the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

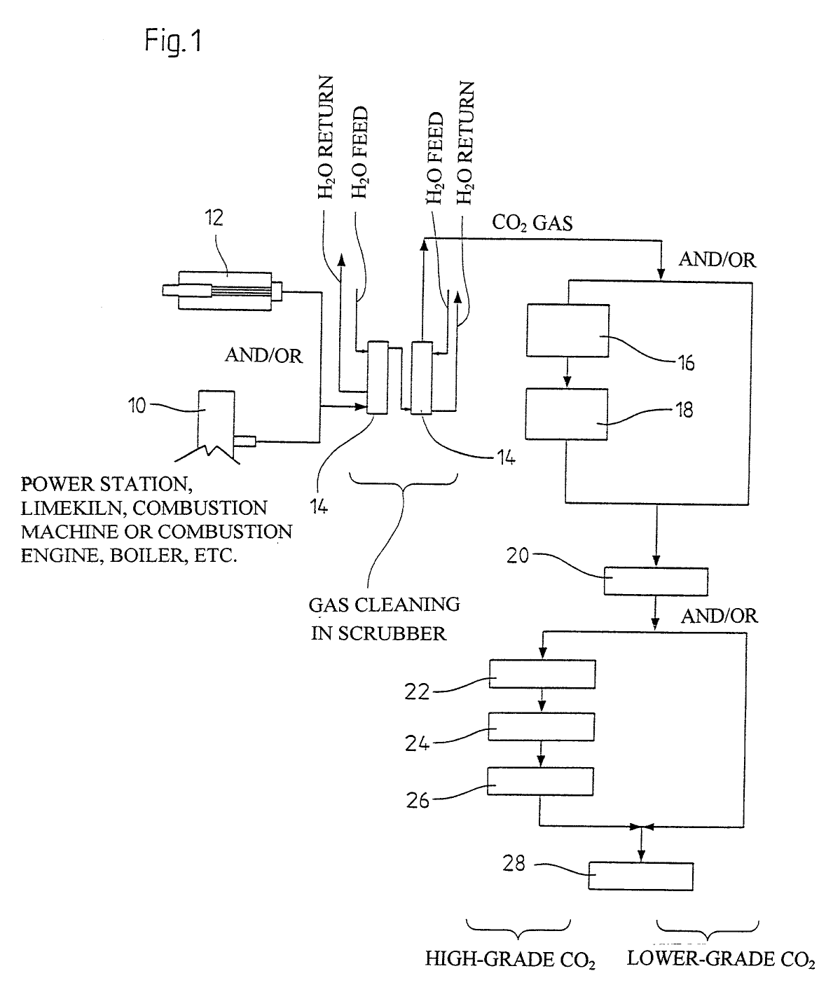

Referring now to FIG. 1 there is shown a procedure to load fibers contained in a pulp suspension with an additive by means of a chemical precipitation reaction, which is initiated through the addition of carbon dioxide (CO₂).

In this process, the carbon dioxide is produced with a degree of purity of ≦99%, preferably of ≦85%, and is then added to the pulp suspension. For reasons of process technology and economic viability, it is advantageous for the carbon dioxide to be produced in a range of between approximately 65% and approximately 99%, preferably in a range of between approximately 75% and approximately 85%, before being added to the pulp suspension.

The carbon dioxide may, in particular, be generated from the waste gas of a fuel, or through lime burning or a similar process. As shown in FIG. 1, the carbon dioxide can, in particular, be generated from the waste gas of a power station, a limekiln, a combustion engine or combustion machine, a boiler and/or a similar apparatus.

Alternatively, the carbon dioxide may be produced from the waste gas obtained from direct firing of any desired fossil fuel. As shown in FIG. 1, the waste gas of boiler 12 may be used in this way.

The waste gas produced in the combustion process can then be submitted to a washing process, for example, to wash out major and solid contaminants from the waste gas. One or more wet tower scrubbers 14 may be employed for this washing process. In the present example, two tower scrubbers 14 of this type are provided. Water circulation for these tower scrubbers 14 is also depicted in FIG. 1.

The CO₂ gas may then optionally be submitted to absorption process 16 and/or cleaning process 18. In the course of absorption process 16, the gas may be absorbed in an absorber liquid. The absorber liquid can contain aqueous monoethanolamine (MEA) and/or a soda ash and/or copper carbonate and water mixture, for example. Subsequent to this, the absorbed carbon dioxide can be precipitated, whereby it can optionally also be cooled. Advantageously, at least one part of the process steps described above is performed in a counter-current direction, in order to increase efficiency. Alternatively, both steps 16 and 18 may be omitted. The gas can then optionally be compressed using CO₂ compressor 20.

The carbon dioxide can then optionally be fed into CO₂ dryer 22, CO₂ liquefaction stage 24 and CO₂ storage stage 26.

For liquefaction, the gas may be compressed, and preferably cooled, and the liquid carbon dioxide may then be stored in a pressurized tank, and thus made available for the fiber loading process 28.

Steps 22 to 26, which are particularly intended for high-grade CO₂, may alternatively be omitted. The CO₂ will then be lower grade, which is however, still perfectly sufficient for subsequent fiber loading process 28.

The carbon dioxide in a gaseous state may also be introduced directly into fiber loading process 28, in particular after washing/precipitation. In cases where the carbon dioxide is not placed in temporary storage, the processes of compression and cooling may be omitted, at least in part, since the CO₂ gas need only be cooled or heated to its final desired temperature. In this procedure, neither purification (i.e. odor neutralization) nor ultra purification is required. The carbon dioxide is then fed into actual fiber loading process 28.

In the course of this process, calcium oxide and/or calcium hydroxide (hydrated lime) may be added in such a way that at least a portion thereof becomes associated with the water contained in the fibrous material (i.e. between the fibers, in the hollow fibers and in the walls of the fibers), whereby the following chemical reaction takes place.

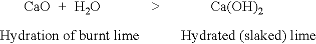

In the reactor, the fibrous material processed in this manner is then charged with carbon dioxide (CO₂), which has been produced in the aforementioned manner, in such a way that calcium carbonate (CaCO₃) is deposited on the wetted fiber surfaces to the greatest possible extent. This involves the following chemical reaction:

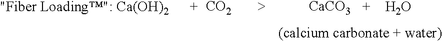

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for loading fibers contained in a pulp suspension with an additive, comprising the steps of:
producing carbon dioxide having a degree of purity of ≦99%;
adding said carbon dioxide to the pulp suspension; and
initiating a chemical precipitation reaction in the pulp suspension by the addition of said carbon dioxide.

2. The method of claim 1, wherein said degree of purity is ≦85%.

3. The method of claim 1, wherein said carbon dioxide is produced from a waste gas of combustion from one of a fuel and lime.

4. The method of claim 3, wherein said carbon dioxide is produced from the waste gas of combustion from at least one of a power station, a combustion engine, a boiler and direct firing of a fossil fuel.

5. The method of claim 3, including the step of submitting the waste gas produced in combustion to a washing process.

6. The method of claim 5, wherein said washing process washes out major and solid contaminants from the waste gas.

7. The method of claim 5, wherein said washing process is carried out using at least one wet tower scrubber.

8. The method of claim 5, including the step of submitting the waste gas to an absorption process in an absorber liquid.

9. The method of claim 8, wherein the waste gas is submitted to said absorption process in said absorber liquid subsequent to said washing process.

10. The method of claim 8, wherein said absorber liquid contains at least one of a copper carbonate and water mixture, an aqueous monoethanolamine (MEA) and a soda ash.

11. The method of claim 8, including the step of precipitating said carbon dioxide in said absorber to create a liquid carbon dioxide.

12. The method of claim 11, including the step of cooling said liquid carbon dioxide after said precipitating step.

13. The method of claim 8, wherein at least one of said washing process and said absoption process is performed in a counter-current direction.

14. The method of claim 11, including the steps of compressing said liquid carbon dioxide and subsequently storing said carbon dioxide in a pressurized tank before said adding step.

15. The method of claim 14, wherein said liquid carbon dioxide is cooled.

16. The method of claim 14, wherein said liquid carbon dioxide is heated to between approximately 10° C. and approximately 90° C. producing a gaseous carbon dioxide and then fed to said fiber loading process.

17. The method of claim 11, wherein said liquid carbon dioxide is converted to gaseous carbon dioxide and fed to a fiber loading process.

18. The method of claim 17, wherein said gaseous carbon dioxide is heated to between approximately 10° C. and approximately 90° C. before being fed to said fiber loading process.

19. The method of claim 1, wherein said carbon dioxide is compressed.

20. The method of claim 1, wherein said carbon dioxide is produced having an absence of purification, odor neutralization and ultra purification.
